(19) United States
(12) Patent Application Publication
(10) Pub. No.: US 2005/0089622 A1
(43) Pub. Date: Apr. 28, 2005

(54) Prime rib meat product and process of manufacture

(76) Inventors: Dinesh Bhatnagar, Calgary S.E. (CA); Cheng Khim Lim, Calgary (CA); Ronald S. Kovitz, Calgary (CA)

Correspondence Address: Mr. W. Charles Kent;Ridout & Maybee LLP, 150 Metcalfe Street, 19th Floor, Ottawa, ON, K2P 1P1, CA

(21) Appl. No.: 10/845,891

(22) Filed: May 14, 2004

(30) Foreign Application Priority Data
Oct. 28, 2003 (CA) 2,444,785

(51) Int. Cl. A23G 1/00

(52) U.S. Cl. 426/646

(57) ABSTRACT

A prepared ground prime rib meat product and a process for manufacturing same are disclosed, for shaping into patties, meatballs or the like. The product consists of a mixture of different pieces of lean and fat beef prime rib meat, seasoning in the range of 0%-4% and added water in the range of 5%-20% by weight. The meat consists of portions of rib meat which have not traditionally been sold or labelled as prime rib meat.

### FIELD OF THE INVENTION

The present invention relates to prepared foods for human consumption and specifically a prepared meat product and its process of manufacture.

### BACKGROUND OF THE INVENTION

A wide variety of prepared meat products such as pre-made and refrigerated or frozen hamburgers, meatballs, meatloaf and similar types of meat products are popular amongst consumers. Such products typically comprise a mixture of one or more cuts or kinds of meat (usually ground) combined with other components such as seasonings, binders etc. Typically, these products are sold as raw or partly cooked and require cooking by the consumer. Much research has been carried out, for example, in the development of pre-packaged meat products which have various qualities such as a reduced fat content. However, many such products are somewhat lacking in taste, texture (or “mouth feel”) and/or quality. As an increasing number and variety of these products become available to consumers, the demand in the food industry for newer, higher quality and better tasting meat products grows. More particularly, there is a growing demand for higher quality products in the form of easily cooked, fully or semi-prepared foods such as burgers, but which are relatively inexpensive to manufacture and which thus can be offered to consumers at moderate prices. As well, there is a demand for meat products which may be labelled as containing meat cuts or types which have a reputation for high quality such as, in the present instance, “prime rib”. There is thus a need for meat products which may be labelled as “prime rib” and which have the superior flavour and texture associated with prime rib, but at a more economical cost.

The term “prime rib” generally refers to a particularly desirable cut of beef. However, this term in fact bears several meanings. The term is often applied to meat to meat from a particular rib area of beef, namely meat cut from between the 7^{th} to 12^{th} ribs of beef, inclusive. The term “prime” is generally used to refer to the U.S.DA. designation for a superior grade of meat, although the term “prime rib” apparently predates the first USDA grading system and has historically been used to designate the best part of the beef rib section. The level of quality in beef is traditionally based on the meat flavour and tenderness as well as its level of fat and the even distribution of fat within the meat.

Under current USDA and CFIA (Canadian Food Inspection Agency) guidelines, meat or a meat product may be labelled as “prime rib” if it meets certain criteria, including having a minimum content of meat from the aforementioned rib region of beef. A recent interim ruling by the CFIA permits ground meat and ground meat products to be labelled as “prime rib” products provided they contain at least 67% of primal or sub-primal meat (i.e. meat from between the 7^{th} through 12th ribs inclusively of beef) and up to 33% of other ingredients which may include beef trimmings, other meats and food additives such as flavourings. For example, a patty sold in pre-packaged fresh or frozen form may be labelled as a “prime rib” patty if it meets the above conditions.

### SUMMARY OF THE INVENTION

The present invention provides a prepared ground meat product which has a taste, texture, fat content and “mouth feel” which is similar to traditional prime rib (or ground meat products prepared from prime rib), but which can be manufactured relatively inexpensively. The invention consists in general of a mixture containing seasoning, water and a blend of lean beef prime rib meat and fat beef prime rib meat ingredients. The lean beef meat is preferably composed of a combination of lifter rib meat, rib cap meat, beef rib boneless blade meat trim and blade meat. The fat beef meat can be fat caps, beef rib caps or a combination of both.

Although such meats are not commonly associated with the term “prime rib”, they are, in fact, made up of the latissiumus dorsi and the trapezius, which are found in the primal rib region (i.e. 7^{th} to 12 ribs inclusive), and the clod and the wedge meat found medial to the latissiumus dorsi and the trapezius muscle of the primal rib. Similarly, the fat caps are trimmings from the primal rib region. Such meat ingredients are not traditionally used to prepare “prime rib” products and are sometimes simply discarded, while the more desirable cuts of meat are extracted and used as meat products. However, it is the surprising discovery of the present inventors that these previously less desirable meats which nonetheless are within the region from which “prime rib” is traditionally cut can when properly combined and prepared result in a very flavourful ground meat product that may be labelled as “prime rib”. The present invention utilizes a combination of these less traditionally desirable and thus less expensive meat ingredients to create a relatively inexpensive meat product that has the taste, texture and “mouth feel” of ground meat products prepared from traditional prime rib.

It may be noted that for purposes of this specification and claims, the term “lean” meat refers to meat having a fat content, by weight, of between 3% and 20%. “Fat” meat refers to a fat content, by weight, of between 65% and 95%. The fat content is measured when the meat is freshly cut and uncooked. The terms “rib meat” and “prime rib meat” mean unless otherwise noted meat from the region of the 7^{th} to 12^{th} ribs inclusive of beef. This term is not, however, limited to the USDA nor CFIA definitions of “rib” or “prime rib”. Further, the term “ground” refers to meat which is ground in the conventional manner as well as being chopped or the like.

The present invention provides a process for preparing a ground meat product having a taste and texture when cooked which is similar to traditional prime rib products. The process comprises the steps of: a) preparing a meat blend consisting of different cuts of lean and fat beef prime rib meat comprising lean rib meat in the range of 30%-75% by weight of the final mixture and fat beef rib meat from a different source than the lean rib meat, in the range of 20%-45% by weight of the final mixture (the more preferred ranges being about 40%-60% and 25%-40% respectively); b) adding seasoning to the blend in the range of 0%4%, and preferably 2.0%-2.5% by weight of the overall mixture and c) adding additional water in the range of 5%-20%, and preferably 10%-16% by weight of the mixture. The meat components preferably comprise at least 67% by weight of the mixture. An antioxidant is preferably added to the seasoning mix as a preservative. Preferred antioxidants are natural extracts such as rosemary or oregano extract. The above combining steps may be carried out in any order. The mixture is then brought to between 20 and 38 degrees F., with a preferred range being between 26 and 27 degrees F., and then ground and shaped or formed into a desired product configuration. The desired product configuration may be a patty, sausage, meatball, meatloaf or any similar type of meat product. The product may be frozen and packaged for sale to consumers, with a label referring to the product as a “prime rib” product.

The references in this specification and claims to meat from “different sources” refers to meat which comes from different discrete pieces of butchered meat generally representing different cuts. Such pieces may come from the same or a different source animal. References herein to a meat product which emulates or is similar to a prime rib product means that the meat product has a taste and texture which is similar to that which would be obtained from a ground single piece or cut of high-value meat which is traditionally labelled as prime rib and which has been formed into a ground meat product.

The step of grinding the product preferably involves grinding through a standard 3/16 inch hole size of grinding plate.

The invention further comprises a substrate containing the components identified above for forming into a prepared product, as well as prepared and packaged (or ready for packaging) ground meat products such as patties, loafs or meatballs formed from this substrate.

The step of shaping or forming the product is preferably carried out by introducing a meat substrate comprising the above substituents into a mold in a columnar fashion to minimize trapped air within the meat, with the forming process involving applying pressure of between about 90 and 120 psi to the meat within the mold. In one aspect, the end product is a hamburger patty about 0.6 inches thick and it may be surface perforated using a perforation wheel or disk. The depth of perforation may vary, but is preferably about 15% of the average product thickness, with the perforations being made in one or both sides. In another aspect, the thickness of the end product may range from 0.01 inches to 4.0 inches, depending on the type of product. For example, the thin end of this range applies for use of the material when stuffed into a casing, cooked and thinly shaved. The thicker end may apply to a meatloaf. The preferred thickness for a patty is 0.25 to 0.85 inches, with the ideal being about 0.6 to 0.7 inches thick.

Temperatures are presented herein in degrees Fahrenheit. Any quantity or range described or mentioned herein, whether of a given weight of a substance or a range of weights, may vary by 10%. Any reference herein to a qualifier such as “about” is understood to refer to this range of variation. All references to quantities of various components refer to product weight when fresh (prior to freezing or any dehydrating) and uncooked.

The present invention will now be described by way of a non-limiting description of certain detailed embodiments.

### DETAILED DESCRIPTION OF THE INVENTION

A ground meat product comprises a mixture of: a blend of lean beef prime rib meat in the range of 30%-75% by weight and fat beef prime rib meat in the range of 20%45% by weight; seasoning in the range of 0%4% and preferably 2.0%-2.5% by weight of the mixture; and added water in the range of 5%-20% and preferably 10.0%-16% by weight of the mixture. The lean meat is preferably in the range of about 40% to 60% with the most preferred being about 50% by weight of the total mixture. The fat prime rib meat is preferably present in the range of about 25% to 40%, with the most preferred being about 33% by weight.

The lean beef rib meat preferably consists of meat ingredients selected from lifter meat, rib cap meat, beef rib boneless blade meat trim and blade meat. The fat beef meat preferably consists of fat caps and/or beef rib caps. Preferably one or both of the lean and fat beef rib meats should be aged from between 1 and 21 days. Ideal aging conditions involve maintaining a temperature of 26-29 for between 7 and 14 days. The seasoning includes salt, spices and flavouring. As well, an antioxidant may be added. The preferred antioxidant is a natural antioxidant such as rosemary or oregano extract. Other antioxidants such as BHA, BHT or Vitamin E are suitable if permitted by regulation. The meat product has prime rib-like qualities (such as taste and texture) to the consumer when the substrate thus formed is formed into an acceptable form such as a meat patty or burger and cooked.

Additional non-meat substituents may be added, such as any suitable type of flour, soy ingredients, bread or cracker crumbs, egg or milk products. However, the total content of the prime rib meat components is at least 67% by uncooked weight of the mixture.

In another aspect, the present invention provides a process for manufacturing a ground prime rib meat product comprising a substrate for forming a prepared formed meat product. The process commences with the preparation of a mixture of the components described above, followed by forming into a desired product configuration.

The total fat content (before cooking) of the meat substrate may range from about 18%-40%. The ideal fat content is about 30%. The fat content may be adjusted in the mixture by removing a portion of the lean rib meat prior to mixing and replacing same with fat meat. In doing so, it may be necessary to slightly depart from the lean/fat meat ratios described above.

The meat used to prepare the meat blend may be either fresh or frozen, or a blend thereof, with fresh meat being preferred from a quality stand point, while frozen meat is more economical. Any blend of fresh and frozen is suitable, although if frozen (or previously frozen) meat is used it is preferred that this component comprise no more than 40% of the total meat component. Frozen meat should be tempered at 260 prior to forming the meat mixture. The frozen meat is then preferably added to the mixture at a temperature of 30-32° F. at and the fresh meat is best added at a temperature of 32-38° F., with the preferred range being between 35 and 38 degrees F.

The blend of lean and fat beef rib meat is initially combined with the seasoning, water and other optional constituents following which it is processed in a mixer/grinder and then chilled to a temperature of about 26° F.-27° F. The mixture is then ground through a grinding plate, preferably having ⅛-¼ inch hole size. The ground mixture is then introduced into a product mould in a columnar fashion to permit trapped or entrained air to escape and thus to achieve a generally uniform density in the end product. The mixture is then shaped into a desired product such as a burger, meatball, meatloaf or other shape by applying 90-120 psi to the mixture within a mould. The desired product is preferably deep perforated. Once the meat product is shaped into a desired configuration, it can then be frozen.

The invention is further illustrated in an example:

### EXAMPLE 1

Following are the details of a test run:

| | | |
|---|---|---|
| beef prime rib lean meat | 100.6 | kg |
| beef prime rib fat meat | 65.94 | kg |
| Water | 28.46 | kg |
| Spice and flavouring | 5.00 | kg |
| (seasoning) | | |

Antioxidant (rosemary extract at 0.03% by weight-
incorporated into the seasoning unit)

The meats were separately coarse ground and then transferred to a mixer grinder equipped with a 3/16 inch plate. The meats were initially mixed without grinding for 2.5 minutes, analyzed for fat content, and the fat content of the mixture was then adjusted by removing part of the meat mix and replacing it with fat meat to achieve a target fat content of 29%. Water and seasoning components (including antioxidant) were then added and mixed for one minute and then dry ice was introduced into the mixture to chill the mix to a temperature of 26° F.-27° F. The mixture was then ground through the plate. The resulting substrate was formed into hamburger patties using a forming machine adjusted to apply about 90-120 psi to the patties. The resulting patties were then surface perforated with a perforating wheel, packaged and frozen. This process and combination of ingredients produced a product having when cooked a prime rib-like taste, texture and quality.

The added seasonings comprised salt, spices and other flavourings. Antioxidant as described above was also incorporated into the seasoning mix prior to blending of the seasoning into the meat mixture.

The substrate as described above may be mixed with other ingredients such as additional flavourings prior to forming into the end product. For example, horseradish or other suitable ingredients may be added to the substrate either during its preparation or afterwards.

Although the present invention has been described by way of a detailed description in which various embodiments and aspects of the invention have been described, it will be seen by one skilled in the art that the full scope of this invention is not limited to the examples presented herein. Rather, the invention has a scope which is commensurate with the claims of this patent specification including any elements or aspects which would be seen to be equivalent to those set out in the accompanying claims.

1. A ground meat product having when formed and cooked a taste and texture substantially emulating prime rib from a single cut or source piece, comprising:
lean beef prime rib meat in the mount of 30%-75% by weight, said lean meat comprising a fat content of about 3-20% by weight;
fat beef prime rib meat, in the range of 20%45% by weight, said fat meat comprising a fat content of about 65%-95% by weight;
seasoning in the range of 0%4% by weight; and
added water in the range of 5%-20% by weight of the mixture; wherein said lean and fat meat comprises meat from different sources and said mixture is ground to a texture suitable for use in a prepared meat product.

2. A product as defined in claim 1 wherein said lean beef prime rib meat is present in the range of about 40%-60% by weight and said fat beef prime rib meat is present in the range of about 25%-40% by weight.

3. A product as defined in claim 1, wherein the fat content of said product is about 30%.

4. A product as defined in claim 1, wherein said added water is present in the range of about 10%-16% by weight.

5. A product as defined in claim 1, wherein the lean beef meat consists of a combination one or more meat ingredients selected from the group consisting of: lifter meat; rib cap meat; beef rib boneless blade meat trim; and blade meat.

6. A product as defined in claim 1, wherein the fat beef meat consists of fat caps or beef rib caps or both.

7. A product as defined in claim 1, further comprising one or more ingredients selected from: an antioxidant, flour, a soy product, bread crumbs, cracker crumbs, an egg ingredient and a milk ingredient.

8. A product as defined in claim 1 containing at least 67% by weight of prime rib meat.

9. A ground meat product having when formed and cooked substantially the taste and texture of a prime rib product prepared from a single cut or source piece, comprising a mixture of between 30% and 75% by weight lean prime rib meat selected from one or more of lifter meat, rib cap meat, beef boneless blade meat trim and blade meat, said lean rib meat having a fat content of between about 3% and 20% by weight; between 20% and 45% by weight fat prime rib meat from a source different from said lean meat and selected from one or both of fat caps and beef rib caps, said fat prime rib meat comprising a fat content of between 60% and 95% by weight; seasoning comprising up to 4% by weight of said product; and added water comprising between 5% and 20% by weight of said product.

10. A product as defined in claim 9 wherein said lean beef prime rib meat is present in the range of about 40%-60% by weight and said fat beef prime rib meat is present in the range of about 25%-40% by weight.

11. A product as defined in claim 9, wherein the fat content of said product is about 30%.

12. A product as defined in claim 9, wherein said added water is present in the range of about 10%-16%.

13. A product as defined in claim 9 comprising a fresh or frozen pre-shaped moulded product.

14. A ground meat product as defined in claim 13 selected from one of a hamburger patty, a meatball and meatloaf.

15. A product as defined in claim 9 containing at least 67% by weight of prime rib meat.

16. A process for manufacturing a prepared ground prime rib meat product having substantially the taste and texture of a prime rib meat product prepared from a single cut or source piece, said process comprising the steps of:
preparing a mixture of: lean beef prime rib meat in the mount of 30%-75% by weight, said lean meat comprising a fat content of about 3-20% by weight; fat beef prime rib meat, in the range of 20%-45% by weight, said fat meat comprising a fat content of about 65%-95% by weight; seasoning in the range of 0%-4% by weight; and added water in the range of 5%-20% by weight of the mixture; wherein said lean and fat meat comprises meat from different sources;
optionally chilling said mixture;
grinding said mixture; and
forming said mixture into a desired product configuration.

17. A process as defined in claim 16 wherein said lean beef prime rib meat is present in the range of about 40%-60% by weight and said fat beef prime rib meat is present in the range of about 25%-40% by weight.

18. A process as defined in claim 16, wherein the fat content of said product is about 30%.

19. A process as defined in claim 16, wherein said added water is present in the range of about 10%-16%.

20. A process as defined in claim 16, wherein the lean beef meat consists of a combination one or more meat ingredients selected from the group consisting of: lifter meat; rib cap meat; beef rib boneless blade meat trim; and blade meat.

21. A process as defined in claim 16, wherein the fat beef meat consists of fat caps or beef rib caps or both.

22. A process as defined in claim 16 wherein said mixture contains at least 67% by weight of prime rib meat.

23. A process as defined in claim 16, further comprising adding to said mixture one or more ingredients selected from: an antioxidant, flour, a soy product, bread crumbs, cracker crumbs, an egg ingredient and a milk ingredient.

24. A process as defined in claim 16, wherein the blend of lean beef meat and fat beef meat consists of fresh meat in the range of 60%-100% of the blend and frozen meat, in the range of 0%-40% by weight of the blend.

25. A process as defined in claim 16, wherein the mixture is introduced into a product mould in a columnar fashion.

26. A process as defined in claim 16, wherein the product is formed as a hamburger patty.

27. A process as defined in claim 16, wherein the product is formed as a meatloaf product.

28. A process as defined in claim 16, wherein the product is surface perforated after being formed.

29. A process as defined in claim 16, wherein the product is frozen after it has been shaped into its desired product configuration, packaged and labelled as a “prime rib” product.
